(19) United States
(12) Patent Application Publication
(10) Pub. No.: US 2023/0280040 A1
(43) Pub. Date: Sep. 7, 2023

(54) METHOD OF CONTROLLING A COOKING SYSTEM AND RELATED COOKING SYSTEM

(71) Applicant: WHIRLPOOL CORPORATION, Benton Harbor, MI (US)

(72) Inventors: Alessandro Boccotti, Biandronno (IT); Andrea Gallivanoni, Casorate Sempione (IT); Gaia Mannara, Varese (IT); Annalisa Pacioni, Bresso (IT); Davide Parachini, Cassano Magnago (IT); Cristiano Vito Pastore, Comerio (IT)

(73) Assignee: WHIRLPOOL CORPORATION, Benton Harbor, MI (US)

(21) Appl. No.: 18/116,470

(22) Filed: Mar. 2, 2023

(30) Foreign Application Priority Data
Mar. 4, 2022 (EP) 22160270.9

(51) Int. Cl. F24C 7/08

(52) U.S. Cl. CPC F24C 7/083; F24C 7/087

(57) ABSTRACT

Operations such as adding food or flipping or otherwise manipulating food in an item of cookware being heated may be detected by comparing with a threshold the time derivative of a sensed temperature and/or of heating power absorbed by an item of cookware, wherein the heating power is provided by an induction cooktop operated in order to keep constant the temperature value sensed by the sensors coupled to the item of cookware.

### CROSS-REFERENCE TO RELATED APPLICATION

This application claims priority to European Patent Application No. 22160270.9, filed on 4 Mar. 2022, entitled “METHOD OF CONTROLLING A COOKING SYSTEM AND RELATED COOKING SYSTEM,” the disclosure of which is hereby incorporated herein by reference in its entirety.

### BACKGROUND OF THE DISCLOSURE

This disclosure relates generally to the field of cooking appliances and more specifically to a method of controlling a cooking system for monitoring a cooking process using an induction cooktop, and to a related cooking system.

Assistance in cooking is desirable, such as to assure food temperature and doneness. Cooking pans are used in cooking but provide no assistance in monitoring food temperature or doneness.

### SUMMARY

Studies carried out by the inventors have shown that certain operations carried out during cooking, such as adding food or flipping food in an item of cookware being heated, cause a sudden decrease of temperature sensed by the sensors coupled to the item of cookware and/or an increase of heating power absorption by the induction cooktop, which is operated so as to keep constant the cooking temperature of the item of cookware. In theory, it could be possible to detect food insertion and/or manipulation by detecting these variations of sensed temperature, but this technique may be relevantly influenced by the type of food and by the positioning of the temperature sensor within or outside the cookware.

According to this disclosure, operations such as adding food or flipping food in an item of cookware being heated are detected by comparing with a threshold the time derivative of sensed temperature of an item of cookware and/or of heating power provided by an induction cooktop operated in order to keep constant the temperature value sensed by the sensors coupled to the item of cookware.

A method of controlling a cooking system for monitoring implementation of a recipe by means of a related cooking system comprising an induction cooktop functionally coupled with an item of cookware equipped with a temperature sensor and with a microprocessor control unit, is disclosed herein.

### BRIEF DESCRIPTION OF THE DRAWINGS

In the drawings:

FIG. 1 depicts exemplary time graphs of: a) power (W) provided to a pan on the induction cooktop; b) pan temperature (° C.) sensed by a sensor on the induction cooktop; c) the time derivative of pan temperature (° C.); and d) the time derivative of power (W) provided to the induction cooktop; and

FIG. 2 depicts a block diagram of a cooking system according to this disclosure.

### DETAILED DESCRIPTION

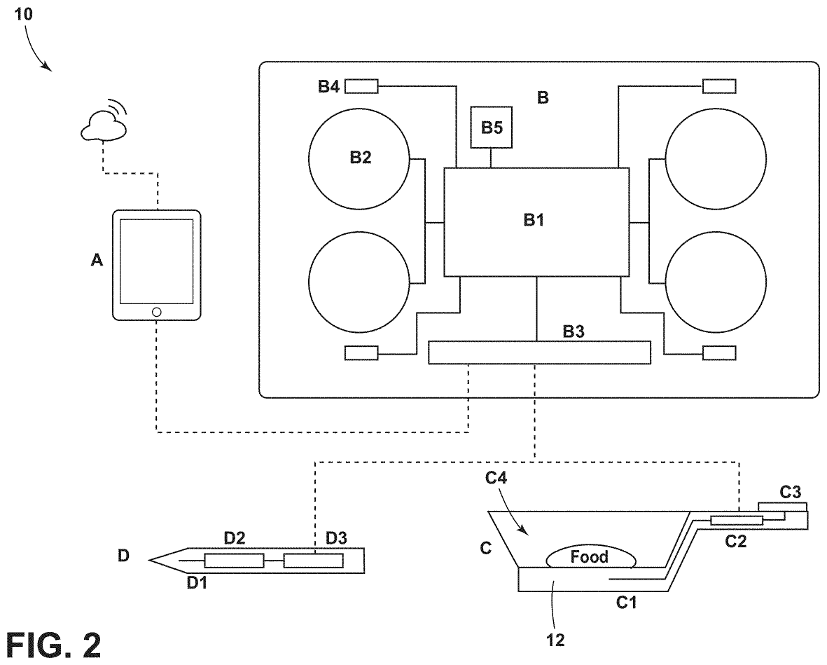

Referring to FIG. 2, what will be disclosed hereinafter applies to a cooking system 10 having at least an induction cooktop B, at least an item of cookware C—such as a pan—and a sensor B4, C1, D1, for determining a thermal parameter, preferably a temperature, of the item of cookware C and/or of one or more food items (“Food” in FIG. 2) contained in the item of cookware C. The induction cooktop B is configured to determine a power that the induction cooktop B itself provides to the item of cookware C, wherein the induction cooktop B is provided with a closed-loop controller B5 configured to adjust power delivered by the induction cooktop B to the item of cookware C in order to keep substantially constant the cooking temperature of the item of cookware C or of a food contained therein. The sensor could alternatively be the induction coil of the induction cooktop B where electrical parameters such as inductance could be utilized to determine the thermal parameter.

The sensor B4, C1, D1 for determining the power absorbed by the item of cookware C, being heated, may be the same sensor B4, C1, D1 configured for determining the temperature of the item of cookware C, or may be another device embedded in the induction cooktop B. According to one aspect, the sensor B4, C1, D1 for determining the power absorbed by the item of cookware C or for determining the temperature of the item of cookware C may be embedded in a bulk 12 of the item of cookware C (e.g., sensor C1), or may be of an external device D which is inserted in a cavity C4 of the item of cookware C or even in the food contained therein.

An example of the cooking system 10 according to this disclosure is depicted in FIG. 2. It may comprise the induction cooktop B having an induction power converter B1, at least one cooking zone B2, an interface B3 which communicates with the sensor C1, which may be a temperature sensor installed in the item of cookware C (which in FIG. 2 is a pan), and the closed-loop controller B5. Optionally, the induction cooktop B may also embed at least one sensor B4, preferably at least one temperature sensor B4, configured to sense a thermal parameter, preferably a temperature, of the item of cookware C and/or the one or more food items contained therein when the item of cookware C is placed on the at least one cooking zone B2. The closed-loop controller B5 may be configured to adjust power delivered by the induction power converter B1 to the item of cookware C based upon information received from the sensor C1 or B4 in order to keep substantially constant a cooking temperature.

Optionally, the item of cookware C may include a battery C2 for powering the sensor C1 and a dedicated interface C3 functionally connected to the battery C2 and to the sensor C1 for reading a sensed value and for transmitting to the interface B3 of the induction cooktop B. Associated with battery C2 can be electronics able to read and process output originating from sensor C1.

Preferably, the sensor C1 is a temperature sensor configured to sense the temperature of the item of cookware C (e.g., pan).

According to one aspect, in addition or in substitution to the temperature sensor C1 embedded in the item of cookware C, it is possible to insert directly in the food to be cooked a probe D (a so-called “smart probe”), having at least one temperature sensor D1. According to optional aspects, the probe D may be equipped with a battery D2 and with a dedicated interface D3 configured to exchange information with the interface B3 of the induction cooktop B. If a smart probe D is available, then it is possible to implement the method of this disclosure also using a common pan not provided with embedded temperature sensors C1.

Thanks to the closed-loop controller B5, the induction cooktop B is operated in order to heat the pan up to a nominal cooking temperature and to keep the pan at this nominal cooking temperature while the food placed therein is being cooked.

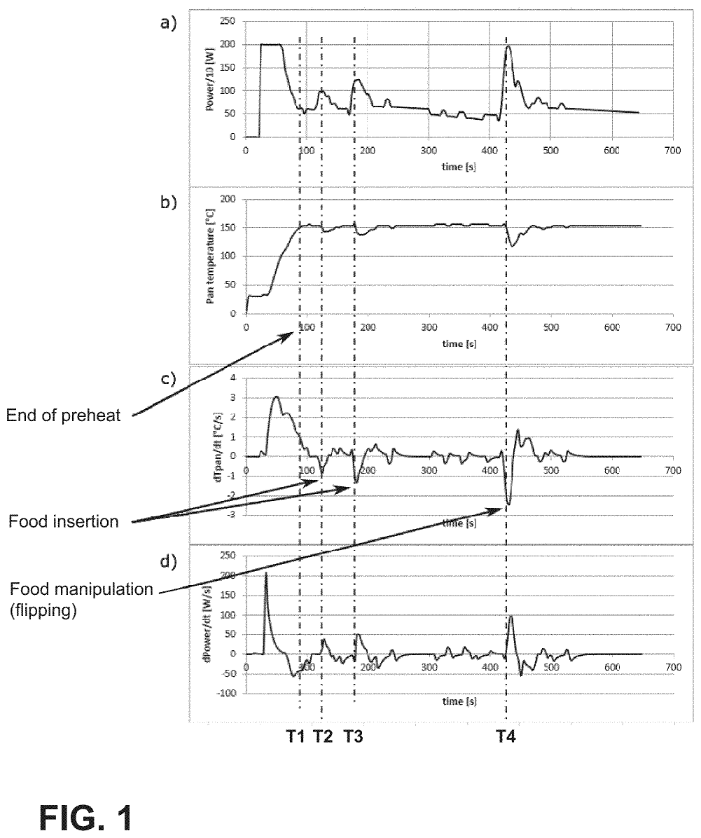

FIG. 1 shows exemplary time graphs of power absorption a), of temperature b), of the time derivatives of temperature c) and of absorbed heating power d) by the item of cookware C, while cooking food. As shown in the time graphs a) and b) of FIG. 1, the pan C is initially at room temperature and there is a preliminary heating phase in which a maximum heating power is provided to the item of cookware C to attain a certain temperature. When the nominal temperature is attained, the closed-loop controller B5 operates the induction cooktop B to keep constant the temperature sensed by the sensor B4, C1, D1 coupled to the item of cookware C, thus the heating power is decreased.

At the instant T1 the pre-heating phase of the item of cookware C is over. After the instant T1, the food can be inserted in the item of cookware C and from the instant T1 onwards power provided to the item of cookware C is adjusted to keep substantially constant the cooking temperature.

According to this disclosure, it has been noticed that it is possible to detect operations carried out by users while cooking food, such as food insertion and/or manipulation, by processing power absorption or temperature rate of change and by determining when rate of change exceeds predetermined threshold, either in the positive or negative direction. Tests carried out by the Applicant have shown that wide and abrupt variations of time derivative of sensed temperature, and/or time derivative of power absorption, occur while inserting and/or manipulating food, and this information may be used to verify whether the cooking of food is being carried out according to a chosen cooking recipe.

As shown in the time graphs of FIG. 1, when food is inserted in the item of cookware C, or when food is flipped or otherwise manipulated while being cooked, there is a sudden decrease of temperature values sensed by the sensors B4, C1, D1, coupled to the item itself, thus the control system operates the induction cooktop B to increase heating power to keep constant the temperature. These sudden variations of heating power and/or of sensed temperature are clearly visible in the time graphs c) and/or d) of FIG. 1, because they generate large spikes. Other manipulations of the food might include stirring, among other things.

More in detail, at the instants T2 and T3, pieces of raw food are inserted in the item of cookware C and the temperature sensor C1 senses a small reduction of cooking temperature because the heated item of cookware C is in contact with the raw food, typically at room temperature. This temperature reduction is too small to be detected in a reliable manner, but the time derivative of the temperature (time graph c) in FIG. 1 sensed by the sensor C1 undergoes a relatively large and abrupt variation that may be reliably detected. The same applies to the time derivative of the power (time graph d) in FIG. 1) absorbed by the item of cookware C, because the interface B3 detects the reduction of temperature sensed by the sensor C1 and thus the induction cooktop B is operated accordingly to increase power delivered to the item of cookware C to maintain a substantially constant cooking temperature. This abrupt and relatively large variation of the time derivative of the heating power absorbed by the item of cookware C (or of the item of cookware C temperature) may be detected by comparing the time derivative with a threshold.

It has been noticed that the time derivative of the item of cookware C temperature or of the power absorbed by the item of cookware C varies abruptly also when the raw food being cooked in the item of cookware C is flipped or otherwise manipulated (time instant T4 on the graphs of FIG. 1).

Therefore, by monitoring the time derivative of the item of cookware C temperature or of the power absorbed by the item of cookware C in the cooking system 10 in which the induction cooktop B is configured to keep substantially constant the cooking temperature of an item of cookware C provided with at least one sensor C1 (for example a so-called “smart pan”), it is possible to monitor the execution of a cooking recipe by determining when food is inserted in the item of cookware C or is flipped or otherwise manipulated.

Typically, the induction cooktop B will act to regulate the cooking temperature of the item of cookware within a relatively narrow range centered around a nominal cooking temperature, for example in a range of +−5° C.

According to one aspect of this disclosure, the induction cooktop B generates an event detection signal when a threshold value is overcome by the time derivative of sensed temperature and/or of heating power absorbed by the item of cookware C.

According to one aspect, it is possible to generate with the induction cooktop B a first logic signal for flagging an end of a pre-heating phase when the sensor B4, C1, D, has attained for a first time the cooking temperature, and to generate with the induction cooktop B a second logic signal for signaling that food has been inserted or flipped into (or otherwise manipulated within) the item of cookware C when the event detection signal is generated after the end of the pre-heating phase.

According to one aspect, the interface B3 of the induction cooktop B may communicate with a microprocessor unit, for example of a smartphone or of a tablet A. A user may select a recipe with the smartphone or tablet A and the cooking system 10, by implementing the method of this disclosure, may monitor the correct execution of the recipe by recognizing if the user has inserted the food to be cooked in the pan C and if he/she has flipped (or otherwise manipulated) it at the right instant. Further, the substantially constant temperature to be maintained can be a function of a step of the recipe, such that different steps of the recipe can call for different cooking temperatures. The event detection signal might trigger the progression to the following recipe step in an automated way without requiring user input. The following recipe step can require a different substantially constant cooking temperature that the previous receipt step and that different substantially constant cooking temperature is controlled as described herein.

According to one aspect, the interface B3 of the induction cooktop B may be connected in a wired mode or in wireless mode to the “smart” item of cookware, and/or to the smartphone or tablet A. When the temperature of the pan C has attained a desired value, the interface B3 of the induction cooktop B receives this information and the induction cooktop B is operated to reduce the delivered heating power. Through the connection to the smartphone or tablet A, or using a display (not shown in the figures) functionally connected to the induction cooktop B, the cooking system 10 might call consumers to insert food in the item of cookware. Thanks to the detection of spikes of the time derivative of the heating power delivered to the pan or of the time derivative of the temperature of the pan or of the food contained therein, it is possible to monitor the addition of raw food in the pan or the instants in which the food being cooked is flipped or otherwise manipulated. Identification of the instances in which the food is flipped or otherwise manipulated could be used as indication that a step of a recipe has been completed.

What is claimed is:

1. A method of controlling a cooking system, wherein the cooking system comprises:
an induction cooktop comprising: an induction power converter, a controller, at least one cooking zone, and an interface functionally connected with the induction power converter;
an item of cookware; and
at least one sensor, wherein the at least one sensor is configured to sense a temperature, of (i) the item of cookware, (ii) one or more food items contained in the item of cookware, or (iii) both (i) and (ii) when the item of cookware is placed on the at least one cooking zone,
wherein the controller is configured to adjust power delivered by the induction power converter to the item of cookware based upon information received from the at least one sensor in order to control the temperature of the item of cookware or of the one or more food items contained in the item of cookware;
the method comprising:
determining an active power delivered by the at least one cooking zone;
controlling, via the controller, a heating power that the induction power converter delivers to the item of cookware in order to control the temperature of the item of cookware;
determining, with the at least one sensor, the temperature or a heating power absorbed by the item of cookware;
determining a time rate of change of the temperature or the heating power absorbed by the item of cookware;
comparing the time rate of change with a threshold value; and
generating, with the induction cooktop, an event detection signal when the threshold value is overcome.

2. The method of claim 1, wherein
generating the event detection signal comprises:
outputting a first logic signal for flagging an end of a pre-heating phase when the at least one sensor has attained for a first time the cooking temperature; and
outputting a second logic signal for signaling that food has been inserted into or manipulated within the item of cookware when the event detection signal is generated after the end of the pre-heating phase.

3. The method of claim 1, wherein the threshold value is either positive or negative and the time rate of change is either positive or negative.

4. The method of claim 1 further comprising:
connecting a tablet or a smartphone to the interface;
receiving with the tablet or smartphone the event detection signal, and
checking execution of a cooking recipe with the tablet or smartphone using the event detection signal.

5. A cooking system comprising:
an induction cooktop comprising: an induction power converter, a controller, at least one cooking zone, and an interface functionally connected with the induction power converter;
an item of cookware, and
at least one sensor configured to sense (i) a temperature of the item of cookware or one or more food items contained in the item of cookware when the item of cookware is placed on the at least one cooking zone or (ii) a heating power absorbed by the item of cookware,
wherein the controller is configured to:
control the induction power converter to adjust the heating power delivered by the induction power converter to the item of cookware based upon information received from the at least one sensor in order to achieve and maintain a cooking temperature of the item of cookware or of a food contained in the item of cookware,
determine with the at least one sensor a current value of temperature or a current value of heating power absorbed by the item of cookware;
determine a time rate of change of the current value of temperature or of the current value of heating power absorbed by the item of cookware;
compare the time rate of change with a threshold value; and
generate an event detection signal when the determined time rate of change exceeds the threshold value in either a positive or negative direction.

6. The cooking system of claim 5, wherein the at least one sensor is installed in a bulk portion of the item of cookware.

7. The cooking system of claim 5, wherein the at least one sensor is a probe configured to be inserted into the food or into a cavity of the item of cookware.

8. The cooking system of claim 5, wherein the at least one sensor is installed in the induction cooktop.

9. The cooking system of claim 5, wherein the at least one sensor is a temperature sensor configured to sense a temperature of the item of cookware.

10. The cooking system of claim 5 further comprising:
a tablet or a smartphone connected to the interface of the induction cooktop, wherein the tablet or smartphone is configured to receive the event detection signal as a feedback for checking execution of a cooking recipe.

11. An induction cooktop comprising:
a cooking zone positioned to accept an item of cookware upon the cooking zone;
an induction power converter configured to deliver power to the item of cookware; and
a controller in communication with the induction power converter, the controller configured:
to control the power that the induction power converter delivers to the item of cookware;
to determine a temperature as a function of time of the item of cookware or the food as a function of the data received from the sensor; and
to determine a derivative of the temperature as a function of time from the determined temperature as a function of time.

12. The induction cooktop of claim 11, wherein
the controller is further configured to compare the determined derivative of the temperature as a function of time to a predetermined threshold derivative.

13. The induction cooktop of claim 12, wherein
the controller is further configured to estimate, as a function of the comparison of the determined derivative of the temperature as a function of time to the predetermined threshold derivative, at least one of (i) that the food has been added to the item of cookware and (ii) that the food has been flipped or otherwise manipulated within the item of cookware.

14. The induction cooktop of claim 13, wherein
the controller is configured to estimate both (i) that the food has been added to the item of cookware and (ii) that the food has been flipped or otherwise manipulated within the item of cookware.

15. The induction cooktop of claim 13, wherein
the controller is further configured to estimate, as a function of the comparison of the determined derivative of the temperature as a function of time to the predetermined threshold derivative, that a step of a cooking recipe has been executed.

16. The induction cooktop of claim 12 further comprising:
an interface in communication with the controller, the interface being configured to communicate with a smartphone or tablet;
wherein, after comparing the determined derivative of the temperature as a function of time to the predetermined threshold derivative, the controller is configured to cause the interface to communicate with the smartphone or tablet a result of the comparison.

17. The induction cooktop of claim 11 further comprising:
the sensor from which the controller is configured to receive data.

18. The induction cooktop of claim 17, wherein
the sensor is a component of the item of cookware or a probe that is inserted into a cavity of the item of cookware or the food.

19. The induction cooktop of claim 17, wherein
the controller is further configured to control the power that the induction power converter delivers to the item of cookware as a function of data received from the sensor.

20. The induction cooktop of claim 17, wherein
the controller is further configured to control the power that the induction power converter delivers to the item of cookware as a function of data received from the sensor in order to achieve and maintain a cooking temperature for the food.
